(19) United States
(12) Patent Application Publication
(10) Pub. No.: US 2008/0023574 A1
(43) Pub. Date: Jan. 31, 2008

(54) Friction grip adjustable sprinkler riser apparatus

(76) Inventor: Robert Gregory Smith, Ponte Vedra Beach, FL (US)

Correspondence Address: DILLER, RAMIK & WIGHT, 7345 MCWHORTER PLACE, SUITE 101, ANNANDALE, VA, 22003, US

(21) Appl. No.: 11/808,021

(22) Filed: Jun. 6, 2007

Related U.S. Application Data
(60) Provisional application No. 60/834,405, filed on Jul. 31, 2006.

(51) Int. Cl. B05B 15/06; F16L 27/12

(52) U.S. Cl. 239/204

(57) ABSTRACT

An adjustable friction grip sprinkler riser includes a body defining a chamber, at least one port for introducing water into the chamber and a riser tube axially slidable relative to the chamber with an upper end thereof being adapted to carry a sprinkler head. The riser tube passes through a member for frictionally gripping an exterior surface thereof to frictionally lock the riser tube at any position of selective adjustment.

### CROSS-REFERENCE TO RELATED APPLICATION

This application is a non-provisional application of provisional application Ser. No. 60/834,405 filed on Jul. 31, 2006 in the name of R. Gregory Smith, MD and entitled Friction Grip Adjustable Sprinkler Riser Apparatus.

### BACKGROUND OF THE INVENTION

The invention is in the field of adjustable sprinkler riser apparatuses such as disclosed in U.S. Pat. No. 4,274,592 in the name of Daryl Westhusin issued on Jun. 23, 1981 and entitled Adjustable Riser Member. The sprinkler of this patent includes an exterior tubular body, a first tubular riser having internal threads housed within the sprinkler body and a second tubular riser having external threads in threaded engagement with the first tubular riser. The second tubular riser carries a sprinkler head and by threading and unthreading the second tubular riser the height of the sprinkler head relative to a ground surface can be established.

A similar sprinkler assembly having an adjustable riser member is disclosed in U.S. Pat. No. 5,133,501 issued on Jul. 28, 1992 to William R. Marshall and entitled “Landscape Sprinkler System with Adjustable Riser.” In the sprinkler of this patent a riser member can be raised or lowered relative to a main support body assembly by rotating the riser assembly utilizing a wrench or the like.

Another adjustable riser for a lawn sprinkler is disclosed in U.S. Pat. No. 1,833,040 issued on Nov. 24, 1931 to Harold K. Rader and entitled “Adjustable Extension for Sprinkler Assembly.” In this sprinkler assembly a riser having an externally threaded lower end portion is threaded to internal threads of a cylindrical outermost sprinkler body to achieve adjustment of the riser. A separate packing associated with a packing nut achieves a fluid seal between the riser and the main body of the sprinkler.

U.S. Pat. No. 3,369,828 issued on Feb. 20, 1968 to William J. Trickey and entitled “Adjustable Riser for Sprinkler Systems” discloses an outer tubular main body within which slides a riser which at its lower end carries an expandable and retractable ring for respectively frictionally locking and unlocking the lower end of the riser to an internal bore of the sprinkler body.

The latter patents are representative of related prior art found during a prior art search of the present invention which includes collectively the following patents:

| | |
|---|---|
| 782,552 | Glauber |
| 1,833,040¹ | Rader |
| 3,083,914 | Smith et al. |
| 3,369,828 | Trickey |
| 3,563,575 | Sanford |
| 4,003,520 | Bailey |
| 4,007,877 | Jackson et al. |
| 4,274,592² | Westhusin |
| 4,519,544 | Szaboo |
| 4,643,523 | Smedley et al. |
| 5,133,501 | Marshall |
| 5,141,255 | Hanaoka |
| 6,050,500 | Ensworth |
| 6,193,168 | Bedford |
| 6,808,127 | McNulty et al. |
| 6,874,696 | Ericksen et al. |
| 6,959,880 | Swingley |

¹Earlier cited in paragraph.
²Earlier cited in paragraph.

### SUMMARY OF THE INVENTION

The invention provides a novel and unobvious adjustable sprinkler riser apparatus utilizing a novel friction grip principal for static or dynamic positioning and adjustment of a sprinkler riser. The latter structure allows easy adjustment of a below surface mounted sprinkler head in an up or down position or side-to-side without the need of disturbing the surrounding surface or digging. A sprinkler head carried by an upper end of a riser tube can thereby be readily adjusted up or down or side-to-side when the adjustable riser apparatus is used above the ground or the surrounding surface, i.e., when watering shrubbery beds where sprinkler head height requires sprinkler adjustment due to growth, often within the growing plan itself. The adjustable sprinkler riser apparatus also allows easy removal of a sprinkler head placed below or above ground or another surface for necessary maintenance, repair or replacement which is usually accomplished without disturbing the surrounding surface or digging.

Through the novel and unobvious construction of the adjustable sprinkler riser apparatus of the present invention, the riser or riser tube can be frictionally gripped, statically or dynamically in any desired vertical position and the riser or riser tube can be rotated through 360° absent the utilization of tools of any kind. The adjustable sprinkler riser of the invention is thereby extremely versatile, it is easy to use and handle whether during adjustment or to make repairs, and the latter simplifies both installation and maintenance while the specific location of the novel friction grip mechanism precludes the entry of dirt and grit into the main body of the sprinkler thereby eliminating clogging or, as is the case of prior art devices, renders conventional sprinkler risers virtually useless or hard to adjust. The simplicity of the adjustable sprinkler riser assembly also permits ease of manufacture from common plastics, metals or other materials/compounds currently available and frequently used in apparatus of this type.

More specifically, the adjustable sprinkler riser apparatus of the present invention includes a main body defining a chamber into which fluid/water is introduced and a riser or riser tube relative slidable with respect thereto. The riser tube includes respective upper and lower ends respectively internally and externally of the chamber with the exterior end being adapted to carry a conventional sprinkler head. Means are provided for frictionally gripping an exterior surface of the riser tube to frictionally lock the riser tube at any position of selected adjustment of the riser tube with respect to the main body.

Preferably, the frictional gripping means includes a member constructed from friction material defined by an exterior peripheral portion and an interior peripheral friction portion defining an opening through which the riser tubes slides in frictional gripping relationship and is thereby frictionally grippingly retained in any desired position of vertical adjustment.

In further accordance with this invention, the friction member is also preferably constructed from flexible fluid sealing material, such that the riser tube is not only frictionally gripped and thereby retained in any position of vertical adjustment, but water leakage between the riser tube and the friction member is avoided.

With the above and other objects in view that will hereinafter appear, the nature of the invention will be more clearly understood by reference to the following detailed description, the appended claims and the several views illustrated in the accompanying drawings.

### BRIEF DESCRIPTION OF THE DRAWINGS

FIG. 1 is an axial cross-sectional view through the adjustable sprinkler riser apparatus of the invention, and illustrates a main tubular body defining a water chamber, a riser or riser tube axially slidable within the chamber, and frictional gripping means in the form of a member formed of flexible friction material having an opening within and relative to which the riser tube slides and is frictionally gripped in any desired position of vertical adjustment.

FIG. 2 is a vertical side elevational view of the adjustable sprinkler riser apparatus, and illustrates by the unnumbered spiral arrow the manner in which the riser tube can be simultaneously drawn upwardly and rotated to pull the same to any position of adjustment beyond that illustrated in FIG. 1.

FIG. 3 is a cross-sectional view taken generally along line 3-3 of FIG. 1, and illustrates an internal peripheral frictional gripping surface of the frictional gripping means or member in frictional gripping engagement with an exterior cylindrical surface of the riser tube for frictionally locking the latter in any position of desired vertical adjustment.

FIG. 4A is a perspective view, and illustrates the adjustable sprinkler riser apparatus with its riser or riser tube in its fully retracted position.

FIG. 4B is a perspective view, and illustrates the adjustable sprinkler riser apparatus with its riser or riser tube in its fully extended position.

FIG. 5, which appears on the drawing sheet containing FIGS. 1 through 3, is a top plan view of the frictional gripping member, and illustrates a central cylindrical sleeve or sleeve portion thereof and an associated peripheral flange.

FIG. 6, which appears on the drawing sheet containing FIGS. 1 through 3 and 5, is a side elevational view of the frictional member of FIG. 5, and illustrates in more detail the configuration thereof.

FIG. 7, which appears on the drawing sheet containing FIGS. 1 through 3, 5 and 6, is a top plan view, and illustrates an internally threaded nut which is secured to a lower externally threaded end portion of the riser tube to prevent the total removal thereof in an upward direction, as viewed in FIG. 5, beyond the frictional gripping member.

FIG. 8, which appears on the drawing sheet containing FIGS. 1 through 3 and 5 through 7, is a cross-sectional view taken generally along line 8-8 of FIG. 1, and illustrates a male plug threaded into a lowermost inlet opening of the riser main body.

FIG. 9A is a diagrammatic side elevational view of the friction grip adjustable sprinkler riser apparatus of the present invention, and illustrates the same mounted in a below ground/surface retracted position attached to a water supply line by a lateral internally threaded female water inlet.

FIG. 9B is a diagrammatic side elevational view of the apparatus of FIG. 9A, and illustrates the riser or riser tube in its fully extended position after having been gripped, pulled upwardly and rotated as diagrammatically indicated by the unnumbered headed arrows of FIG. 9A.

FIG. 9C is a diagrammatic side elevational view of the apparatus of the present invention, and illustrates the same mounted in an above ground/surface retracted position, and illustrates a water supply line connected to a lowermost water inlet of the main body.

FIG. 9D is a diagrammatic side elevational view of the above ground/surface position of the apparatus of FIG. 9C, and illustrates the riser or riser tube in its fully extended position.

### DETAILED DESCRIPTION OF THE INVENTION

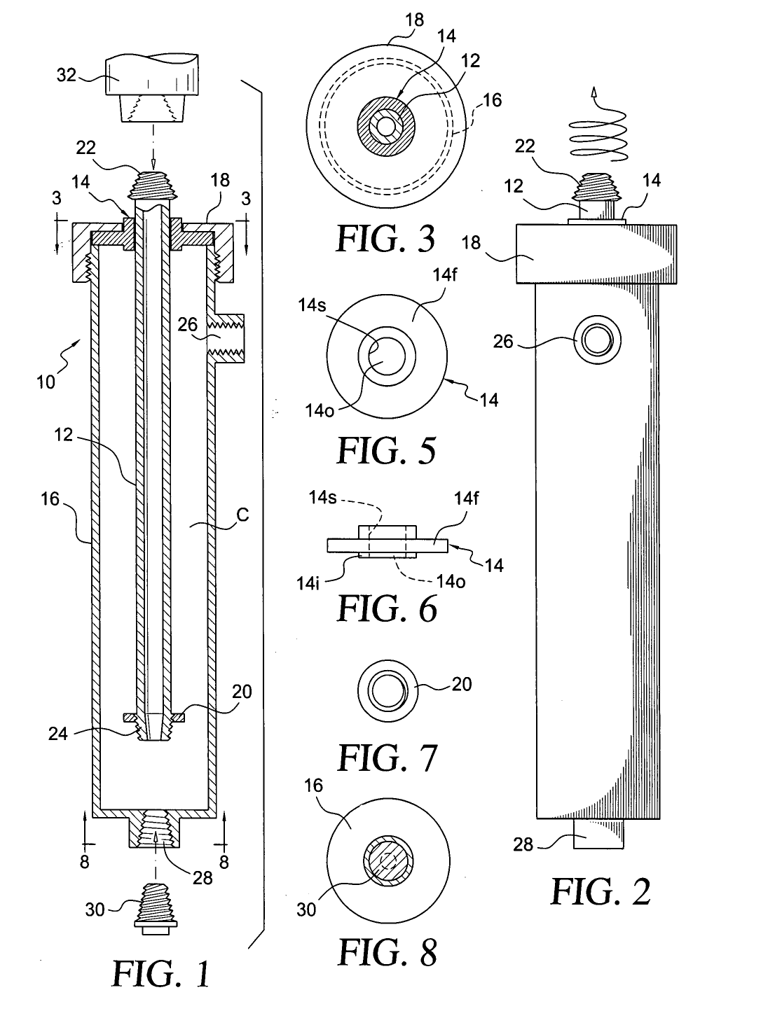

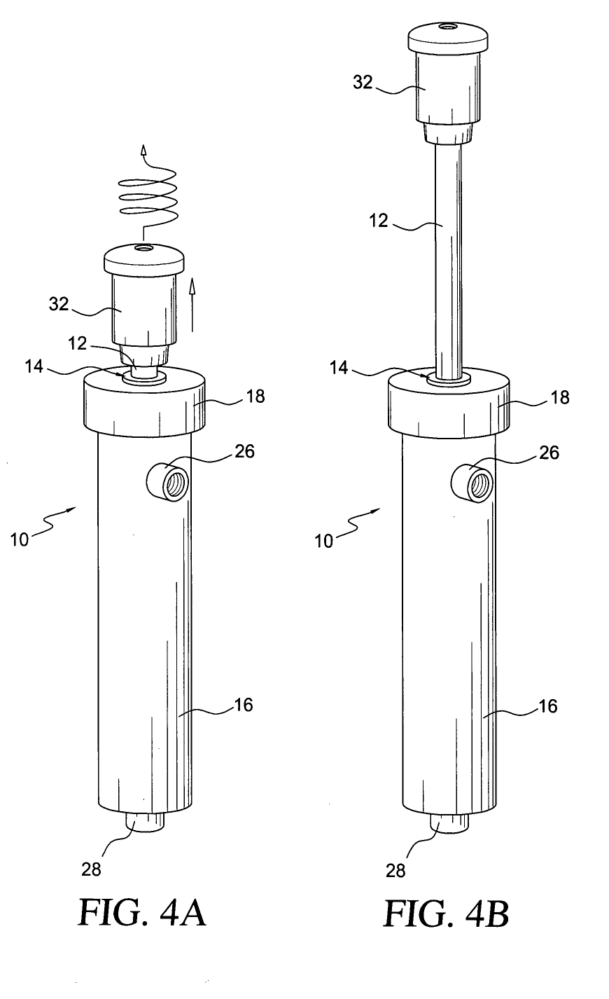

A novel friction grip adjustable sprinkler riser apparatus of the invention is fully illustrated in FIGS. 1 through 8 of the drawings and is generally designated by the reference numeral 10.

The friction grip adjustable sprinkler riser apparatus 10 includes a conventional sprinkler riser or riser tube 12 which is axially slidable in a chamber C of a main body 16. The riser or riser tube 12 includes axially opposite externally threaded end portions 22, 24, the latter of which carries a threaded nut 20. The main body 16 includes means 26 and 28 for introducing fluid/water from a conventional supply into the chamber C of the main body 16. The fluid/water introducing means are internally threaded lateral and axial ports 26, 28, respectively, into which can be selectively threaded an externally threaded male plug 30.

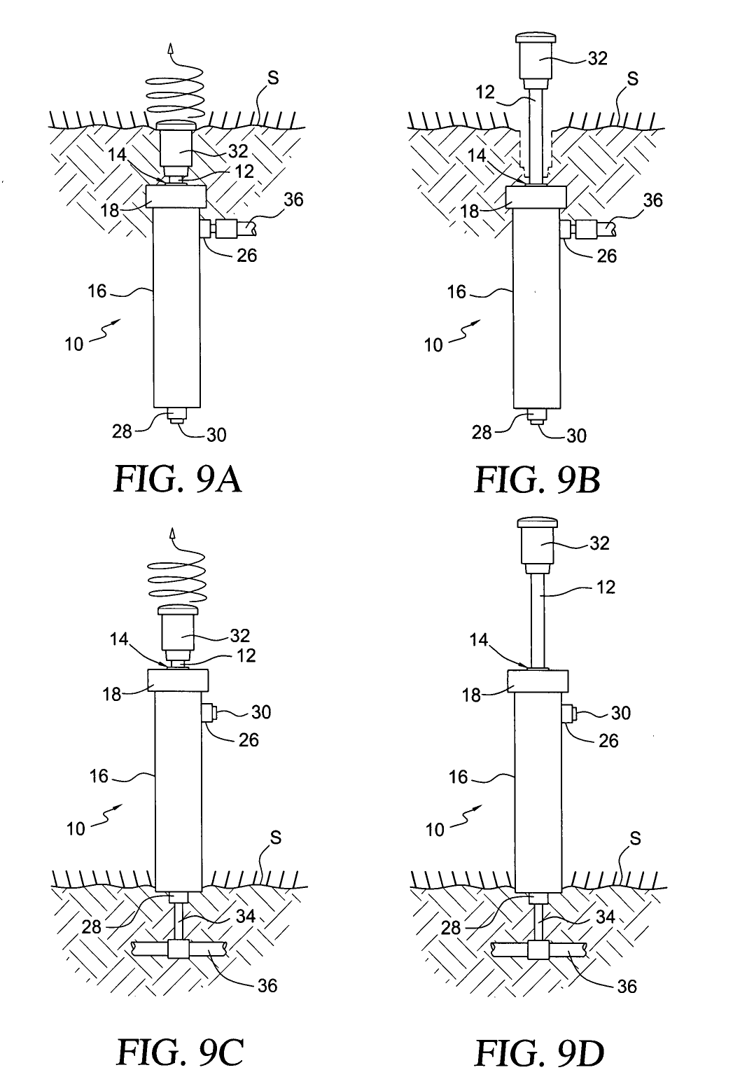

The riser or riser tube 12 slides axially relative to both the main body 16 and means 14 for frictionally gripping an exterior surface (unnumbered) of the riser or riser tube 12 to frictionally lock the riser tube 12 at any position of selected adjustment to accurately locate a conventional sprinkler head 32 threaded upon the threaded end portion 22 of the riser tube 12 relative to a surface S for either in-ground (FIGS. 9A and 9B) or above ground (FIGS. 9C and 9D) sprinkler systems.

The frictional gripping means 14 is a member constructed from flexible friction material, namely, material which has a high coefficient of friction, and includes an opening 14₀ defining an interior generally cylindrical friction surface 14ₛ of an inner peripheral sleeve or sleeve-like portion 14ᵢ and a radially outwardly projecting peripheral flange 14_{f}. The opening 14ₒ of the cylindrical friction surface 14ₛ of the frictional gripping means 14 is slightly smaller than the exterior circumference (unnumbered) of the riser or riser tube 12 thereby establishing a strong friction grip therebetween sufficient to frictionally lock the riser 12 in any desired vertical and rotational position of relative adjustment with respect to the main body 16, particularly under conventional water pressure within the chamber C of the main body 16.

Means 18 in the form of a screw cap having a radially inward directed flange (unnumbered) and an internally threaded skirt (unnumbered) which threads to an exterior thread (unnumbered) of an upper end portion of the main body 16 functions to clampingly secure the frictional gripping member 14 in its operative position sandwiched between an upper terminal edge (unnumbered) of the main body 16 and the flange (unnumbered) of the screw cap 18. It should be particularly noted that the frictional gripping means 14 and the exterior surface of the riser 12 also creates a fluid/water seal therebetween which prevents water/fluid leakage and additionally prevents dirt or other materials from entering and/or clogging components of the apparatus 10.

Therefore, since the outer diameter of the sprinkler or riser tube 12 is slightly greater than the inner diameter of the opening 14, of the frictional gripping means or flexible friction gripping and positioning collar/seal 14, the friction therebetween singularly is effective to hold the sprinkler riser 12 in any selected static position under normal operating water pressure. As is also readily apparent from FIG. 1, any effort toward upwardly retracting the riser 12 beyond the flexible friction gripping means 14 through the opening 14ₒ is prevented by the bottoming of the threaded nut 20 against the underside (unnumbered) of the sleeve portion 14ₛ of the flexible friction gripping/positioning collar/seal 14.

The operation of the friction grip adjustable sprinkler riser apparatus 10 is simple and straightforward and, depending upon whether below or above ground use, requires only (a) the threaded attachment of the conventional sprinkler head 32 to the threaded end portion 22 of the riser 12 and (b) the connection of a water source (not shown) through a water line 36 to the lateral inlet port 26 (FIGS. 9A and 9B) for a below-ground installation and through the utilization of a standard/conventional fixed riser 34 (FIGS. 9C and 9D) to the inlet port 28 in which cases the threaded male plug 30 is respectively connected to the axial water inlet port 28 (FIGS. 9A and 9B) and the lateral water inlet port 26 (FIGS. 9C and 9D).

In the case of below ground/surface S installation (FIGS. 9A and 9B), the desired position of the sprinkler head 32 is established, and the latter is usually mounted flush or slightly above the surface S (FIG. 9A). The latter position is accomplished by grasping the sprinkler head 32 and twisting it in a clockwise (or counterclockwise) direction and pulling it up or pushing it down, as indicated by the unnumbered headed arrows in FIG. 9A to achieve the desired height level of use which will be maintained by the frictional locking means 14 in the manner heretofore described. The twisting and simultaneous pushing or pulling motion (FIG. 9A) temporarily over-comes the frictional grip holding the riser or riser tube 12 in a static position and allows dynamic adjustment thereof. Usually, the external male threaded end portion 22 of the riser 12 is left extended approximately one inch (1″) above the screw cap 18 upon installation of the apparatus 10 so that the sprinkler head 32 can be adjusted up or down over time to the changing level of the surrounding surface S (FIG. 9A) without having to disturb the latter surface or dig into the same. This is a very common scenario with lawn sprinklers. The water supply is then turned on and the flexible friction gripping means or grip positioning collar/seal 14 prevents axial movement of the riser 12 and the attached sprinkler head 32 under standard water pressure while simultaneously preventing water leakage therebetween.

For later adjustment of the level of the sprinkler head 32 relative to the just described below the surface S of the friction grip adjustable sprinkler riser apparatus 10 of FIG. 9A wherein the surrounding surface level of the surface S has changed over time, one need merely grasp the sprinkler head 32 and twist it clockwise (or counterclockwise) while pulling it up or pushing it down to the new desired level. This maneuver may be performed without disturbing the surrounding surface S (FIG. 9A) or digging. As previously described, this is particularly useful when the level of the lawn surface S changes with growth of grass or erosion of the surrounding surface over time. This also allows protruding sprinkler heads 32 to be adjusted downward to proper position relative to the surrounding surface S to prevent passersby from stumbling over them or allows partially buried sprinkler heads 32 to be elevated to the proper working position to make them more efficient.

With respect to the maintenance or replacement of the sprinkler head 32 in a below-the-surface installation (FIGS. 9A and 9B), the user need only grasp the sprinkler head 32 and again twist the same with a clockwise or counterclockwise motion and pull the sprinkler head 32 up to the desired height, as is illustrated in FIG. 9B. The sprinkler head 32 may now be easily removed from the externally threaded male end portion 22 of the riser 12 by holding the riser 12 stationary with one's hand or pliers or other suitable grasping device and using the other hand or suitable grasping device to unscrew the sprinkler head 32 in a counterclockwise direction resulting in the removal thereof for a repair or replacement. A new or reconditioned sprinkler head 32 can then be reattached to the male threaded head portion 32 of the riser 12 by screwing it on in a clockwise manner while holding the riser 12 in a stationary position. The sprinkler head 32 can then be repositioned to the desired working level (FIG. 9A) by grasping it and turning it clockwise or counterclockwise and simultaneously pushing it down from the position shown in FIG. 9B to the position shown in FIG. 9A. During the latter described manipulations, the flexible friction gripping/sealing means 14 prevents any appreciable dirt and grit from entering the apparatus 10.

The riser 12 can also be repaired should a traumatic blow to the sprinkler head 32 cause fracture of the riser 12 at or approximate the upper threaded end portion 22 thereof. If, for example, the riser 12 suffers a fracture usually within one inch of the external male threaded end portion 22, pliers or a suitable grasping device or a riser extraction tool can be used to twist the riser 12 clockwise or counterclockwise, while pulling up the same to bring the damaged end of the riser 12 above the surrounding surface S (FIG. 9B) for repair. The riser 12 can then be repaired by first removing the sprinkler head 32 and cutting the riser head 12 below the damaged area. One can then either place a suitable common commercially available slip joint PVC riser extension or a PVC slip joint male threaded end replacement connector over the cut end of the riser 12 and affix it in place with PVC cement or other suitable cement if a different material is used in manufacturing the apparatus 10.

For total replacement of a damaged or worn riser 12 or of the flexible friction gripped positioning collar/seal 14, the friction grip adjustable sprinkler riser apparatus 10 must be uncovered down to the screw cap 18 which can then be unscrewed in a counterclockwise manner allowing the removal of the riser 12, attach nut 20, the internally threaded cap 18 upon its unthreading and therewith the flexible friction gripping member 14, any one or all of which can be replaced or repaired as required. The components are then reassembled and the level of the sprinkler head 32 is readjusted as earlier described herein.

It should also be particularly noted that the sprinkler head 32 can be rotated without vertical movement to correct the spray arc thereof. The sprinkler head 32 is grasped and twisted clockwise until the arc is in the proper position, and this can be done with the apparatus 10 in FIG. 9A without any upward vertical movement of the riser 12. This is particularly useful for adjusting the direction-of-spray of gear/ratchet-type sprinkler heads which are by nature difficult to adjust and often require special adjustment tools.

When the friction grip adjustable sprinkler apparatus 10 is used above the surrounding surface S (FIGS. 9C and 9D), the sprinkler head 32 is adjusted as described earlier by grasping the body of the mounted sprinkler head 32 and turning it clockwise or counterclockwise while simultaneously pulling up or pushing down to adjust the proper height (FIG. 9C), i.e., for watering the surrounding shrubbery, for example. The sprinkler head 32 may also be adjusted to direct its arc side-to-side by rotating or twisting the sprinkler head 32 clockwise or counterclockwise to the proper direction as needed.

Though a preferred embodiment of the invention has been described herein, variations thereof fall within the scope of the present invention, as, for example, utilizing any suitable material or combination of materials in the construction thereof, such as metal, wood, glass, carbon fiber or any suitable synthetic flexible or rigid material, particularly flexible material having a high coefficient of friction in conjunction with the manufacturer of the friction gripping member 14.

Though the friction grip adjustable sprinkler rising apparatus 10 has been described specifically for use in conjunction with long sprinkler heads, the same is also equally appropriate for use with fire sprinkler heads, manufacturing sprinkler heads or other fluid sprinkler heads, such as misters or sprayers which require adjustment relative to the surrounding surface.

The sprinkler riser may also be scaled to any size to accommodate the size of the sprinkler head to be used and the friction grip adjustable sprinkler riser apparatus can also be mounted on a base which may be moved to other locations where a fluid supply is available and can be attached.

Although a preferred embodiment of the invention has been specifically illustrated and described herein, it is to be understood that minor variations may be made in the apparatus without departing from the spirit and scope of the invention, as defined by the appended claims.

What is claimed is:

1. An adjustable friction grip sprinkler riser apparatus comprising a body defining a chamber, means for introducing fluid into said chamber, a riser tube having opposite first and second end portions disposed respectively internally and externally of said chamber, said riser tube being movable relative to said body whereby the position of the riser tube second end portion can be selectively adjusted, and means for frictionally gripping an exterior surface of said riser tube to frictionally lock said riser tube at any position of selected adjustment of said riser tube second end portion.

2. The adjustable friction grip sprinkler riser apparatus as defined in claim 1 wherein said body includes first and second respective lower and upper end portions, and said frictional gripping means is disposed proximate said body upper end portion.

3. The adjustable friction grip sprinkler riser apparatus as defined in claim 1 including second means for introducing fluid into said chamber, and means for selectively closing one of said first-mentioned and second fluid introducing means.

4. The adjustable friction grip sprinkler riser apparatus as defined in claim 1 including means for connecting said frictional gripping means to an upper end portion of said body.

5. The adjustable friction grip sprinkler riser apparatus as defined in claim 1 wherein said frictional gripping means includes a member constructed from flexible friction material, an opening through said friction material, and a friction surface of said opening being in flexible friction gripping relationship with an exterior surface of said riser tube.

6. The adjustable friction grip sprinkler riser apparatus as defined in claim 1 wherein said frictional gripping means includes a friction member defined by an exterior peripheral portion and an interior peripheral friction portion defining an opening through which said riser tube slides in frictional gripping relationship.

7. The adjustable friction grip sprinkler riser apparatus as defined in claim 1 wherein said frictional gripping means includes a friction member defined by an exterior peripheral portion and an interior peripheral friction portion defining an opening through which said riser tube slides in frictional gripping relationship, and means for connecting said friction member exterior peripheral portion to an upper end portion of said body.

8. The adjustable friction grip sprinkler riser apparatus as defined in claim 1 wherein said frictional gripping means includes a friction member defined by an exterior peripheral portion and an interior peripheral friction portion defining an opening through which said riser tube slides in frictional gripping relationship, means for connecting said friction member exterior peripheral portion to an upper end portion of said body, and said friction member exterior peripheral portion is in sandwiched relationship between peripheral portions of said connecting means and said body upper end portion.

9. The adjustable friction grip sprinkler riser apparatus as defined in claim 1 including means for precluding removal of said riser tube through an upper end portion of said body.

10. The adjustable friction grip sprinkler riser apparatus as defined in claim 1 wherein said frictional gripping means includes a friction member defined by an exterior peripheral portion and an interior peripheral friction portion defining an opening through which said riser tube slides in frictional gripping relationship, means for connecting said friction member exterior peripheral portion to an upper end portion of said body, said friction member exterior peripheral portion is in sandwiched relationship between peripheral portions of said connecting means and said body upper end portion, said friction material interior peripheral friction portion is substantially a sleeve, and said friction material exterior peripheral potion is a peripheral flange.

11. The adjustable friction grip sprinkler riser apparatus as defined in claim 1 wherein said frictional gripping means is in fluid sealing relative sliding engagement with said riser tube exterior surface.

12. The adjustable friction grip sprinkler riser apparatus as defined in claim wherein said frictional gripping means includes a member constructed from flexible friction material, an opening through said friction material, and a friction surface of said opening being in flexible friction gripping relationship with an exterior surface of said riser tube.

13. The adjustable friction grip sprinkler riser apparatus as defined in claim 3 wherein said frictional gripping means includes a member constructed from flexible friction material, an opening through said friction material, and a friction surface of said opening being in flexible friction gripping relationship with an exterior surface of said riser tube.

14. The adjustable friction grip sprinkler riser apparatus as defined in claim 4 wherein said frictional gripping means includes a member constructed from flexible friction material, an opening through said friction material, and a friction surface of said opening being in flexible friction gripping relationship with an exterior surface of said riser tube.

15. The adjustable friction grip sprinkler riser apparatus as defined in claim wherein said frictional gripping means includes a friction member defined by an exterior peripheral portion and an interior peripheral friction portion defining an opening through which said riser tube slides in frictional gripping relationship.

16. The adjustable friction grip sprinkler riser apparatus as defined in claim 3 wherein said frictional gripping means includes a friction member defined by an exterior peripheral portion and an interior peripheral friction portion defining an opening through which said riser tube slides in frictional gripping relationship.

17. The adjustable friction grip sprinkler riser apparatus as defined in claim 4 wherein said frictional gripping means includes a friction member defined by an exterior peripheral portion and an interior peripheral friction portion defining an opening through which said riser tube slides in frictional gripping relationship.

18. The adjustable friction grip sprinkler riser apparatus as defined in claim wherein said frictional gripping means includes a friction member defined by an exterior peripheral portion and an interior peripheral friction portion defining an opening through which said riser tube slides in frictional gripping relationship, and means for connecting said friction member exterior peripheral portion to an upper end portion of said body.

19. The adjustable friction grip sprinkler riser apparatus as defined in claim 3 wherein said frictional gripping means includes a friction member defined by an exterior peripheral portion and an interior peripheral friction portion defining an opening through which said riser tube slides in frictional gripping relationship, and means for connecting said friction member exterior peripheral portion to an upper end portion of said body.

20. The adjustable friction grip sprinkler riser apparatus as defined in claim 4 wherein said frictional gripping means includes a friction member defined by an exterior peripheral portion and an interior peripheral friction portion defining an opening through which said riser tube slides in frictional gripping relationship, and means for connecting said friction member exterior peripheral portion to an upper end portion of said body.
